(19) United States
(12) Patent Application Publication
(10) Pub. No.: US 2025/0105939 A1
(43) Pub. Date: Mar. 27, 2025

(54) OPTICAL SPLITTING/COUPLING DEVICE, OPTICAL SUBMARINE CABLE SYSTEM, AND OPTICAL SPLITTING/COUPLING METHOD

(71) Applicant: NEC Corporation, Tokyo (JP)

(72) Inventor: Ryota Abe, Tokyo (JP)

(73) Assignee: NEC Corporation, Tokyo (JP)

(21) Appl. No.: 18/822,831

(22) Filed: Sep. 3, 2024

(30) Foreign Application Priority Data
Sep. 27, 2023 (JP) 2023-164095

(51) Int. Cl. H04J 14/02

(52) U.S. Cl. CPC H04J 14/0212; H04J 14/0205; H04J 14/022; H04J 14/0279

(57) ABSTRACT

An optical splitting/coupling device includes: an integrated OADM circuit; and an optical input/output circuit configured to be removably attachable to the integrated OADM circuit, wherein the integrated OADM circuit generates, from a first optical signal input from a first terminal station and a second optical signal input from the optical input/output circuit, a third optical signal having a second terminal station as a destination and a fourth optical signal having a third terminal station as a destination, and outputs the fourth optical signal to the optical input/output circuit, and generates, from a fifth optical signal input from the second terminal station and a sixth optical signal input from the optical input/output circuit, a seventh optical signal having the first terminal station as a destination and an eighth optical signal having the third terminal station as a destination.

This application is based upon and claims the benefit of priority from Japanese Patent Application No. 2023-164095, filed on Sep. 27, 2023, the disclosure of which is incorporated herein in its entirety by reference.

### TECHNICAL FIELD

The present disclosure relates to an optical splitting/coupling device, an optical submarine cable system, and an optical splitting/coupling method.

### BACKGROUND ART

In an optical submarine cable system, an optical splitting/coupling device may be installed on the sea bottom. For example, a general optical splitting/coupling device multiplexes and demultiplexes an optical signal received from an optical submarine cable connected to three directions, and generates an optical signal according to a destination of each optical signal. The generated optical signal is sent to an optical submarine cable connected to each destination. In relation to the present disclosure, PTL 1 (International Patent Publication No. WO2018/079445) and PTL 2 (International Patent Publication No. WO2022/064913) describe an optical splitting/coupling device having the function described above.

FIG. 8 is a diagram illustrating a configuration of a general optical submarine cable system 8000. The optical submarine cable system 8000 includes a terminal station 81, a terminal station 82, a terminal station 83, and an optical splitting/coupling device 800. All of the terminal stations 81 to 83 are a terminal station installed on land. Each of the terminal stations 81 to 83 is connected to the optical splitting/coupling device 800 via optical fibers 85 to 88. The optical fibers 85 to 88 are included in an optical submarine cable.

The optical splitting/coupling device 800 is a node including an optical add/drop multiplexing (OADM) function, and is also referred to as an OADM node. The optical splitting/coupling device 800 is installed on the sea bottom, and generates an optical signal according to an output destination by demultiplexing and multiplexing an input optical signal for each wavelength. The optical splitting/coupling device 800 is, for example, the optical splitting/coupling device described in PTL 1.

The terminal station 81 transmits a wavelength division multiplexing (WDM) signal including an optical signal [12] and an optical signal [13] to the optical splitting/coupling device 800. A terminal station being a transmission source and a transmission destination of an optical signal is simply indicated in square brackets. For example, the optical signal [12] is an optical signal transmitted from the terminal station 81 to the terminal station 82, and the optical signal [13] is an optical signal transmitted from the terminal station 81 to the terminal station 83. The terminal station 83 receives, from the optical splitting/coupling device 800, the optical signal [13]transmitted from the terminal station 81. Further, the terminal station 83 transmits, to the optical splitting/coupling device 800, the optical signal [32] having the terminal station 82 as a destination. The terminal station 82 receives, from the optical splitting/coupling device 800, the optical signals [12][32] acquired by multiplexing the optical signal [12]transmitted from the terminal station 81 and the optical signal [32]transmitted from the terminal station 83. The optical signals [12][32] are a WDM signal, and wavelength bands of the optical signal [12] and the optical signal [32] do not overlap each other.

With such a configuration, the optical splitting/coupling device 800 transmits the optical signal [13] to the terminal station 83, and also transmits the optical signal [12] and the optical signal [32] to the terminal station 82.

FIG. 9 is a diagram illustrating a configuration of a general optical submarine cable system 8001. The optical submarine cable system 8001 includes an optical splitting/coupling device 810 and terminal stations 81 to 83. The optical splitting/coupling device 810 includes optical splitting/coupling devices 801 and 802. The optical splitting/coupling device 810 can achieve bidirectional transmission between the terminal station 81 and the terminal station 82 by using the optical splitting/coupling devices 801 and 802. A configuration of the optical splitting/coupling devices 801 and 802 is the same as that of the optical splitting/coupling device 800, and is different only in the terminal stations 81 to 83 to and from which an optical signal is input and output. The optical splitting/coupling device 810 having such a configuration can bidirectionally transmit an optical signal to each of the terminal stations 81 to 83. The optical splitting/coupling device 810 includes the two optical splitting/coupling devices 801 and 802. Thus, an optical submarine cable 24 connecting between the terminal station 83 and the optical splitting/coupling device 810 needs four optical fibers.

FIG. 10 is a diagram illustrating a configuration of a general optical submarine cable system 8002. The optical submarine cable system 8002 includes a terminal station 91, a terminal station 92, a terminal station 93, and an optical splitting/coupling device 900. The terminal stations 91 to 93 perform bidirectional communication. All of the terminal stations 91 to 93 are a terminal station installed on land. The terminal stations 91 to 93 and the optical splitting/coupling device 900 are each connected by optical submarine cables 95 to 97. The optical submarine cables 95 to 97 each include two optical fibers.

The optical splitting/coupling device 900 is, for example, the optical splitting/coupling device described in PTL 2. The terminal station 91 outputs optical signals [12][13] to the optical splitting/coupling device 900. The terminal station 92 outputs optical signals [21][23] to the optical splitting/coupling device 900. The terminal station 93 outputs optical signals [31][32] to the optical splitting/coupling device 900. The optical signal [12] is an optical signal transmitted from the terminal station 91 to the terminal station 92, and the optical signal [21] is an optical signal transmitted from the terminal station 92 to the terminal station 91. Further, the optical signals [12][13] are a WDM signal in which wavelengths of the optical signal [12] and the optical signal [13] are multiplexed.

The optical splitting/coupling device 900 receives the optical signals [12][13], the optical signals [21][23], and the optical signals [31][32] from the terminal stations 91 to 93, respectively. The optical splitting/coupling device 900 demultiplexes and multiplexes the received optical signals for each wavelength band. Specifically, the optical splitting/coupling device 900 outputs the optical signals [12][32] to the terminal station 92. The optical signals [12][32] are a WDM signal in which wavelengths of the optical signal [12] and the optical signal [32] are multiplexed. Similarly, the optical splitting/coupling device 900 generates the optical signals [13][23] and outputs the optical signals [13][23] to the terminal station 93, and generates the optical signals [21][31] and outputs the optical signals [21][31] to the terminal station 91.

With such a configuration, the optical splitting/coupling device 900 achieves bidirectional communication with the terminal stations 91 to 93. In the optical submarine cable system 8002, the optical submarine cable 97 connecting between the terminal station 93 and the optical splitting/coupling device 900 needs two optical fibers.

Both of the optical splitting/coupling device 810 and the optical splitting/coupling device 900 can be used as an OADM node of an optical submarine cable system. However, the optical splitting/coupling device 810 and the optical splitting/coupling device 900 are different in a connection form to the terminal station 83 or the terminal station 93. In other words, four optical fibers connect between the optical splitting/coupling device 810 and the terminal station 83, whereas only two optical fibers connect between the optical splitting/coupling device 900 and the terminal station 93.

In this way, the optical splitting/coupling devices 810 and 900 are different in the number of optical fibers needed for connection to the terminal station 83 and the number of optical fibers needed for connection to the terminal station 93. Thus, in an optical submarine cable system using the optical splitting/coupling devices 810 and 900 in a mixed manner, a backup optical splitting/coupling device cannot be shared between both kinds of the devices. In other words, in this case, both of the optical splitting/coupling device 810 and the optical splitting/coupling device 900 need to be prepared as the backup optical splitting/coupling device. This may cause a decrease in efficiency and a cost increase at times of manufacturing and management of an apparatus used in an optical submarine cable system and storage of a backup apparatus.

The present disclosure has an object to provide a technique for forming an optical splitting/coupling device having a configuration that can be shared with an optical splitting/coupling device in a different form.

### SUMMARY

An optical splitting/coupling device according to the present disclosure is an optical splitting/coupling device used in an optical submarine cable system, and includes:
an integrated OADM circuit; and
an optical input/output circuit configured to be removably attachable to the integrated OADM circuit, wherein
the integrated OADM circuit
   generates, from a first optical signal input from a first terminal station and a second optical signal input from the optical input/output circuit, a third optical signal having a second terminal station as a destination and a fourth optical signal having a third terminal station as a destination, and outputs the fourth optical signal to the optical input/output circuit, and
   generates, from a fifth optical signal input from the second terminal station and a sixth optical signal input from the optical input/output circuit, a seventh optical signal having the first terminal station as a destination and an eighth optical signal having the third terminal station as a destination, and outputs the eighth optical signal to the optical input/output circuit, and
the optical input/output circuit generates the second optical signal and the sixth optical signal from an optical signal input from the third terminal station, outputs the second optical signal and the sixth optical signal to the integrated OADM circuit, and couples and outputs the fourth optical signal and the eighth optical signal to the third terminal station.

An optical splitting/coupling method according to the present disclosure is an optical splitting/coupling method of an optical splitting/coupling device that includes an integrated OADM circuit, and an optical input/output circuit configured to be removably attachable to the integrated OADM circuit, and that is used in an optical submarine cable system, and the optical splitting/coupling method includes procedures of:
in the integrated OADM circuit,
generating, from a first optical signal input from a first terminal station and a second optical signal input from the optical input/output circuit, a third optical signal having a second terminal station as a destination and a fourth optical signal having a third terminal station as a destination;
outputting the fourth optical signal to the optical input/output circuit;
generating, from a fifth optical signal input from the second terminal station and a sixth optical signal input from the optical input/output circuit, a seventh optical signal having the first terminal station as a destination and an eighth optical signal having the third terminal station as a destination; and
outputting the eighth optical signal to the optical input/output circuit; and,
in the optical input/output circuit,
generating the second optical signal and the sixth optical signal from an optical signal input from the third terminal station;
outputting the second optical signal and the sixth optical signal to the integrated OADM circuit; and
coupling and outputting the fourth optical signal and the eighth optical signal to the third terminal station.

The present disclosure can provide an optical splitting/coupling device having a configuration that can be shared with an optical splitting/coupling device in a different form.

### BRIEF DESCRIPTION OF THE DRAWINGS

Exemplary features and advantages of the present disclosure will become apparent from the following detailed description when taken with the accompanying drawings in which:

FIG. 1 is a diagram illustrating a configuration example of an optical submarine cable system;

FIG. 2 is a diagram illustrating a configuration example of an optical splitting/coupling device;

FIG. 3 is a diagram illustrating a detailed configuration example of an OADM circuit;

FIG. 4 is a diagram illustrating a detailed configuration example of an OADM circuit;

FIG. 5 is a diagram illustrating a configuration example of an optical submarine cable system;

FIG. 6 is a diagram illustrating a configuration example of an optical submarine cable system;

FIG. 7 is a diagram illustrating a configuration example of an optical splitting/coupling device;

FIG. 8 is a diagram illustrating a configuration of a general optical submarine cable system;

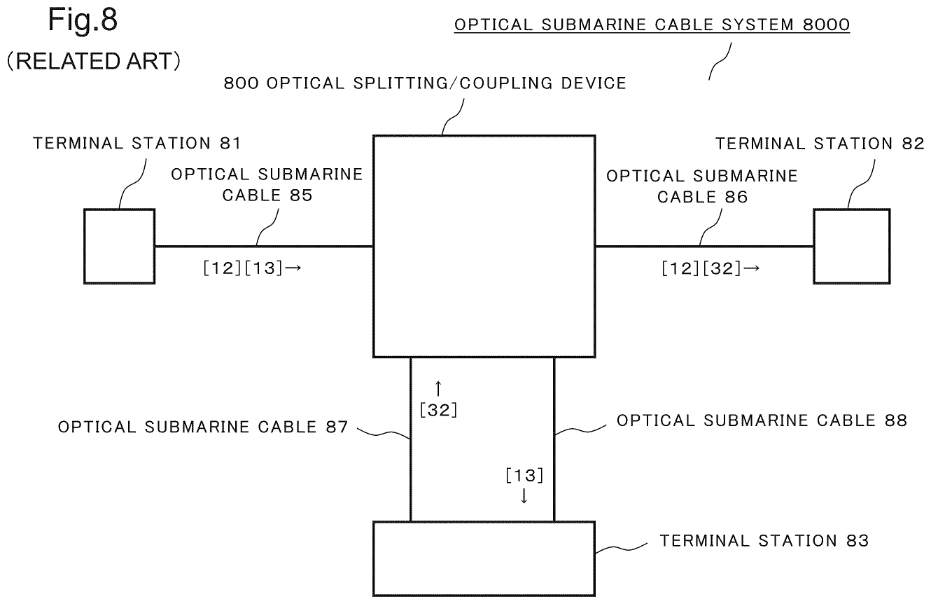

FIG. 9 is a diagram illustrating a configuration of a general optical submarine cable system; and

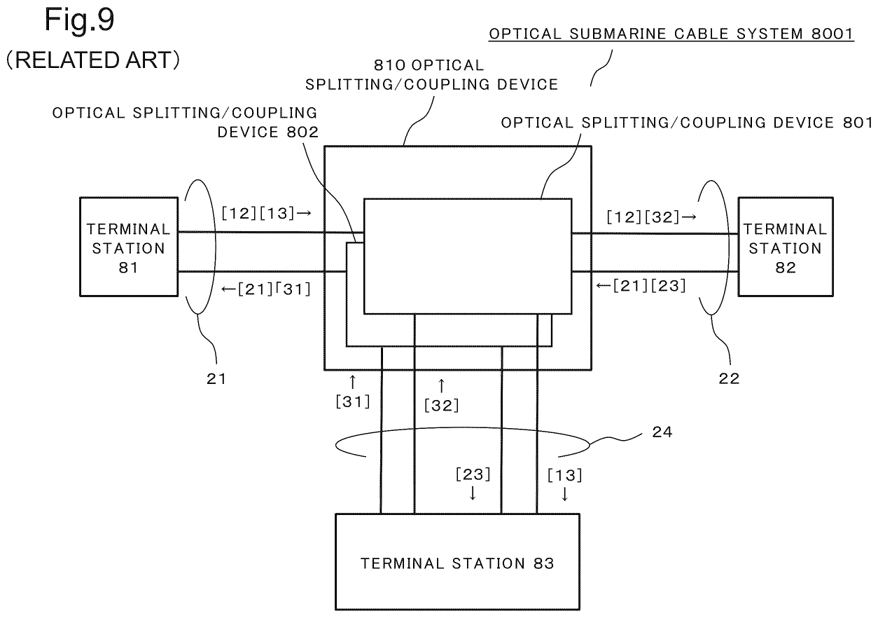

FIG. 10 is a diagram illustrating a configuration of a general optical submarine cable system.

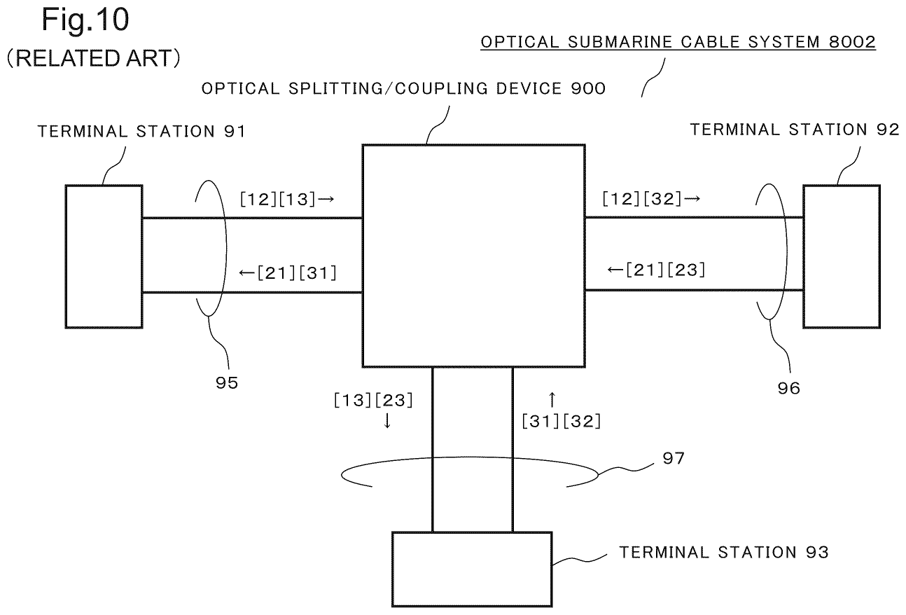

### EXAMPLE EMBODIMENT

Hereinafter, example embodiments of the present disclosure will be described with reference to drawings. An arrow illustrated in the drawings indicates a direction of a signal and the like, and does not intend to impose limitations on a direction and a property of a signal and the like. Further, a component that has already been described may be provided with the same reference sign in the example embodiments and the drawings, and redundant description thereof may be omitted.

### First Example Embodiment

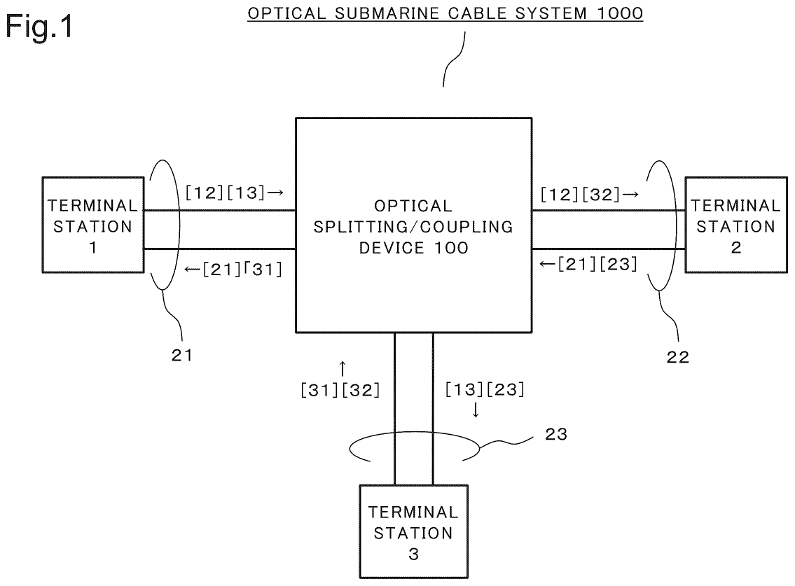

FIG. 1 is a diagram illustrating a configuration example of an optical submarine cable system 1000. The optical submarine cable system 1000 includes an optical splitting/coupling device 100 and terminal stations 1 to 3. The terminal stations 1 to 3 are connected to the optical splitting/coupling device 100 by optical submarine cables 21 to 23, respectively. The optical splitting/coupling device 100 is installed on the sea bottom. All of the terminal stations 1 to 3 are a terminal station installed on land. The terminal stations 1 to 3 are an interface between the optical submarine cable system 1000 and a network system on land. The terminal station 1 and the terminal station 2 may be a trunk station, and the terminal station 3 may be a branch station.

The optical splitting/coupling device 100 and each of the terminal stations 1 to 3 are communicably connected via the optical submarine cables 21 to 23. All of the optical submarine cables 21 to 23 include an optical fiber and a power supply line. Further, all of the optical submarine cables 21 to 23 bidirectionally transmit an optical signal by two optical fibers having different transmission directions of an optical signal. The power supply line is used for supplying power from the terminal stations 1 to 3 to the optical splitting/coupling device 100. In the present example embodiment and subsequent example embodiments, description of the power supply line will be omitted.

The terminal station 1 outputs optical signals [12][13] including the optical signal [12] and the optical signal [13] to the optical splitting/coupling device 100. The optical signal [12] is an optical signal transmitted from the terminal station 1 to the terminal station 2, and the optical signal [13] is an optical signal transmitted from the terminal station 1 to the terminal station 3. Further, the terminal station 1 receives optical signals [21][31] from the optical splitting/coupling device 100. Herein, for example, the optical signals [12][13] are an optical signal in which wavelengths of the optical signal [12] and the optical signal [13] are multiplexed. The optical signals being wavelength-multiplexed are also referred to as a wavelength division multiplexing (WDM) signal. In the present example embodiment and subsequent example embodiments, setting is performed in such a way that wavelength bands of optical signals included in one WDM signal do not overlap each other. For example, in the optical signals [12][13], wavelength bands of the optical signal [12] and the optical signal [13] do not overlap each other.

Similarly, the terminal station 2 transmits optical signals [21][23] to the optical splitting/coupling device 100, and receives optical signals [12][32] from the optical splitting/coupling device 100. The terminal station 3 transmits optical signals [31][32] to the optical splitting/coupling device 100, and receives optical signals [13][23] from the optical splitting/coupling device 100.

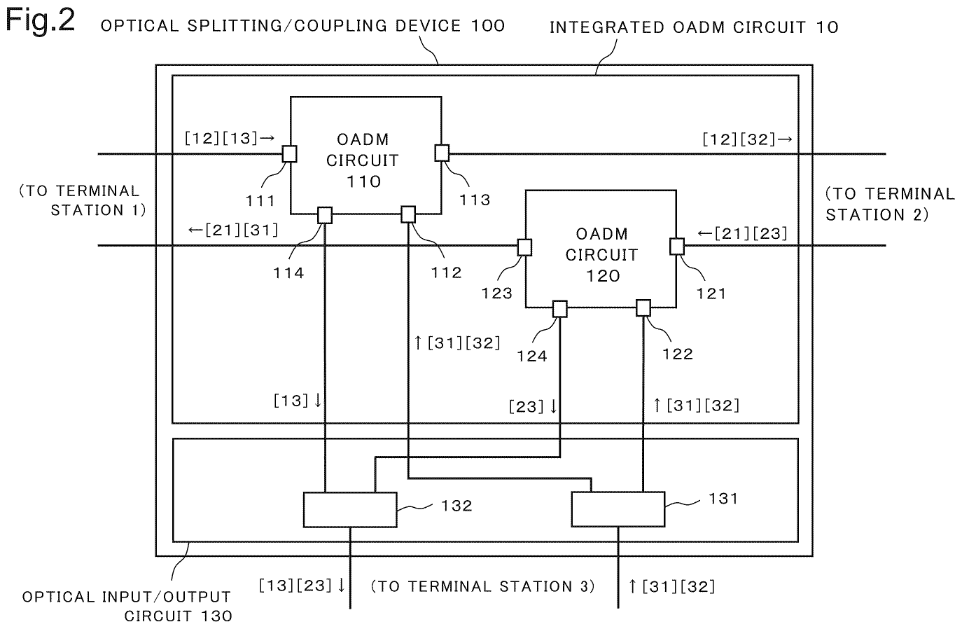

FIG. 2 is a diagram illustrating a configuration example of the optical splitting/coupling device 100. The optical splitting/coupling device 100 includes an integrated OADM circuit 10, and an optical input/output circuit 130 configured to be removably attachable to the integrated OADM circuit 10.

The integrated OADM circuit 10 includes OADM circuits 110 and 120. The OADM circuit 110 multiplexes/demultiplexes the optical signals [12][13] received from the terminal station 1 and the optical signals [31][32] received from the optical input/output circuit 130, and generates the optical signals [12][32] and the optical signal [13]. The OADM circuit 110 transmits the optical signals [12][32] to the terminal station 2, and transmits the optical signal [13] to the optical input/output circuit 130.

The OADM circuit 120 multiplexes/demultiplexes the optical signals [21][23] received from the terminal station 2 and the optical signals [31][32] received from the optical input/output circuit 130, and generates the optical signals [21][31] and the optical signal [23]. The OADM circuit 120 transmits the optical signals [21][31] to the terminal station 1, and transmits the optical signal [23] to the optical input/output circuit 130.

The optical input/output circuit 130 is disposed between the integrated OADM circuit 10 and the terminal station 3. A housing and an optical transmission path of the optical input/output circuit 130 are removably attachable to a housing and an optical transmission path of the integrated OADM circuit 10. For example, the housing of the integrated OADM circuit 10 and the housing of the optical input/output circuit 130 may be fixed by a connection member such as a screw, and the housings may be separable by removing the screw. Further, the optical transmission path between the integrated OADM circuit 10 and the optical input/output circuit 130 may be able to be connected and disconnected by an optical connector.

The optical input/output circuit 130 includes optical couplers 131 and 132. The optical couplers 131 and 132 are, for example, a 1×2 optical coupler. The optical coupler 131 splits the optical signals [31][32] received from the terminal station 3 into two, transmits one to the OADM circuit 110, and transmits the other to the OADM circuit 120. The optical coupler 132 couples the optical signal [13] received from the OADM circuit 110 to the optical signal [23] received from the OADM circuit 120, and transmits the optical signals [13][23] generated by coupling to the terminal station 3. Note that the optical coupler 131 and the optical coupler 132 can be respectively referred to as a first optical coupler and a second optical coupler.

The configuration of the OADM circuit 110 will be described in more detail. The OADM circuit 110 includes a first terminal 111, a second terminal 112, a third terminal 113, and a fourth terminal 114. The optical signals [12][13]transmitted from the terminal station 1 are input to the first terminal 111. The optical signals [31][32]transmitted from the optical input/output circuit 130 are input to the second terminal 112.

The OADM circuit 110 multiplexes and demultiplexes the optical signals [12][13] input from the first terminal 111 and the optical signals [31][32] input from the second terminal 112, and generates the optical signals [12][32] and the optical signal [13]. The optical signals [12][32] are transmitted from the third terminal 113 to the terminal station 2. Further, the optical signal [13] is transmitted from the fourth terminal 114 to the optical input/output circuit 130. The first to fourth terminals 111 to 114 are an input/output point of an optical signal of the OADM circuit 110, i.e., an optical connection point between the OADM circuit 110 and the optical transmission path. The optical connection point is, for example, a fusion connection point of an optical connector or an optical fiber, which is not limited thereto.

The OADM circuit 110 and the OADM circuit 120 are different in an optical signal to be input and output and a connection destination of each terminal. However, internal configurations of the OADM circuit 110 and the OADM circuit 120 are the same. In other words, the OADM circuit 120 includes a first terminal 121, a second terminal 122, a third terminal 123, and a fourth terminal 124. The optical signals [21][23]transmitted from the terminal station 2 are input to the first terminal 121. The optical signals [31][32]transmitted from the optical input/output circuit 130 are input to the second terminal 122.

Note that the OADM circuit 110 and the OADM circuit 120 can be respectively referred to as a first OADM circuit and a second OADM circuit. Further, the first terminal 121, the second terminal 122, the third terminal 123, and the fourth terminal 124 of the OADM circuit 120 can be respectively referred to as a fifth terminal, a sixth terminal, a seventh terminal, and an eighth terminal.

The OADM circuit 120 multiplexes and demultiplexes the optical signals [21][23] input from the first terminal 121 and the optical signals [31][32] input from the second terminal 122, and generates the optical signals [21][31] and the optical signal [23]. The optical signals [21][31] are transmitted from the third terminal 123 to the terminal station 1. Further, the optical signal [13] is transmitted from the fourth terminal 124 to the optical input/output circuit 130. Both of the OADM circuits 110 and 120 may multiplex/demultiplex an optical signal input by using a wavelength selective switch (WSS).

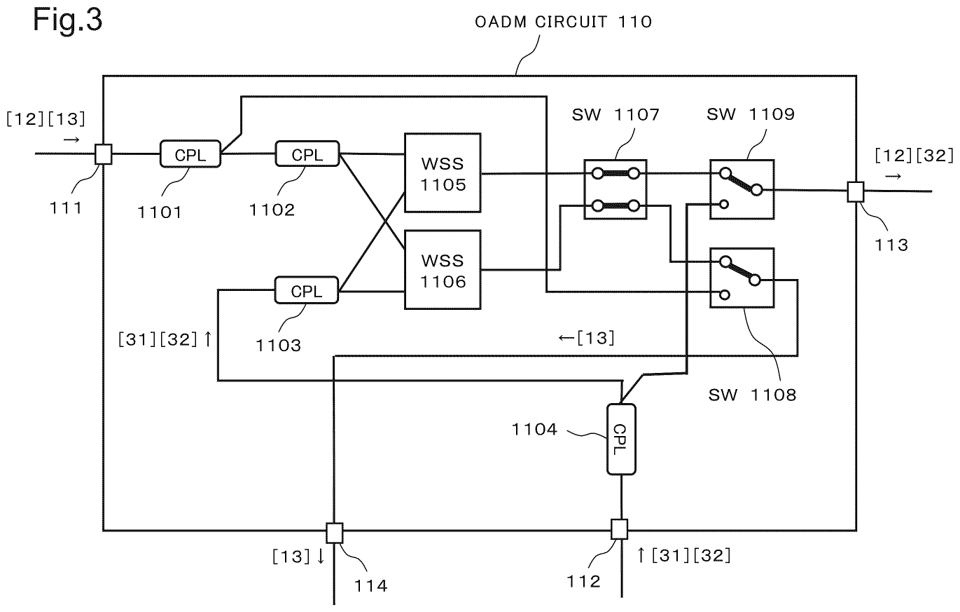

FIG. 3 is a diagram illustrating a detailed configuration example of the OADM circuit 110. The configuration of the OADM circuit 110 illustrated in FIG. 3 conforms to the optical splitting/coupling device described in PTL 1. However, the description in FIG. 3 does not limit a function and a configuration of the OADM circuits 110 and 120.

The OADM circuit 110 includes four optical couplers (CPLs 1101 to 1104), two WSSs (WSSs 1105 to 1106), and three optical switches (SWs 1107 to 1109). As described above, the optical signals [12][13] are input to the first terminal 111, and the optical signals [31][32] are input to the second terminal 112. One of the WSSs 1105 and 1106 generates the optical signals [12][32] from the optical signals, and the other of the WSSs 1105 and 1106 generates the optical signal [13] from the optical signals. The three optical switches 1107 to 1109 are controlled in response to an operation state of the WSS in such a way that the optical signals [12][32] are output from the third terminal 113 and the optical signal [13] is output from the fourth terminal 114.

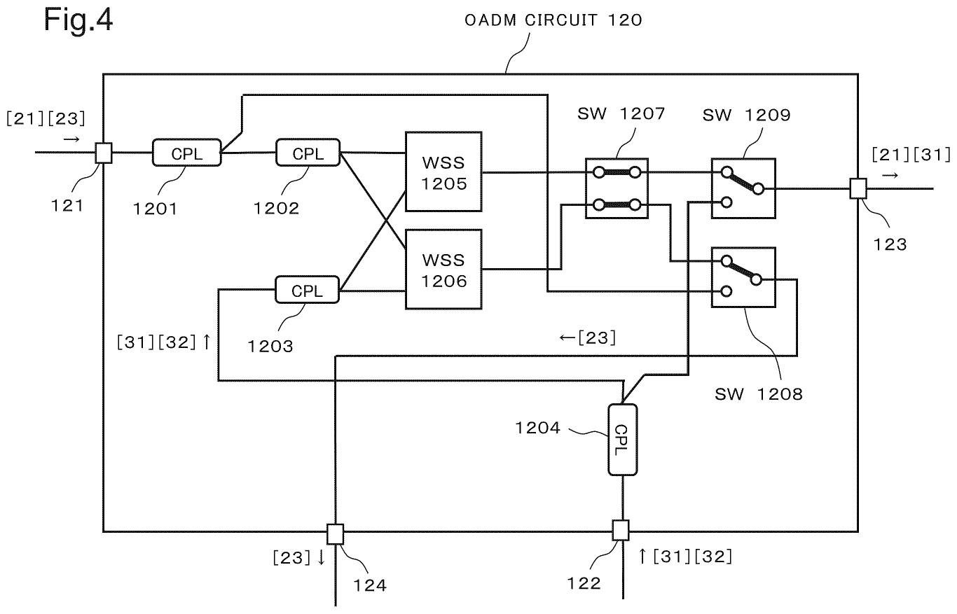

FIG. 4 is a diagram illustrating a detailed configuration example of the OADM circuit 120. Similarly to the OADM circuit 110, the OADM circuit 120 also includes four optical couplers 1201 to 1204, two WSSs 1205 and 1206, and three optical switches 1207 to 1209. The optical signals [21][23] are input to the first terminal 121, and the optical signals [31][32] are input to the second terminal 122. One of the WSSs 1205 and 1206 generates the optical signals [21][31] from the optical signals, and the other of the WSSs 1105 and 1206 generates the optical signal [23] from the optical signals. The three optical switches 1207 to 1209 are controlled in response to an operation state of the WSS in such a way that the optical signals [21][31] are output from the third terminal 123 and the optical signal [23] is output from the fourth terminal 124.

The OADM circuit 110 may have a configuration that can achieve the following function regardless of the configuration in FIG. 3. In other words, the OADM circuit 110 generates the optical signals [12][32] and the optical signal [13] from the optical signals [12][13] input from the first terminal 111 and the optical signals [31][32] input from the second terminal 112. Then, the OADM circuit 110 outputs the optical signals [12][32] from the third terminal 113 and outputs the optical signal [13] from the fourth terminal 114.

Similarly, the OADM circuit 120 may have a configuration that can achieve the following function regardless of the configuration in FIG. 4. In other words, the OADM circuit 120 generates the optical signals [21][31] and the optical signal [23] from the optical signals [21][23] input from the first terminal 121 and the optical signals [31][32] input from the second terminal 122. Then, the OADM circuit 120 outputs the optical signals [21][31] from the third terminal 123 and outputs the optical signal [23] from the fourth terminal 124.

The optical splitting/coupling device 100 having the configuration described above includes the optical input/output circuit 130 in addition to the OADM circuits 110 and 120. With such a configuration, the optical splitting/coupling device 100 can simplify a connection configuration between the terminal station 3, and the OADM circuits 110 and 120. When the optical splitting/coupling device 100 does not include the optical input/output circuit 130, four optical fibers are needed to connect the second terminals 112, 122 and the fourth terminals 114, 124 to the terminal station 3 in order to connect the integrated OADM circuit 10 to the terminal station 3. In contrast, in the optical splitting/coupling device 100, the optical splitting/coupling device 100 can be connected to the terminal station 3 by only two optical fibers.

Note that at least one of the optical couplers 131 and 132 included in the optical input/output circuit 130 may be an optical multiplexer/demultiplexer. For example, the optical input/output circuit 130 may include, instead of the optical coupler 131, an optical demultiplexer that demultiplexes the optical signal [31] and the optical signal [32]. In this case, the optical demultiplexer demultiplexes the optical signals [31][32] received from the terminal station 3, transmits the optical signal [32] to the OADM circuit 110, and transmits the optical signal [31] to the OADM circuit 120. Further, the optical input/output circuit 130 may include, instead of the optical coupler 132, an optical multiplexer that multiplexes the optical signal [13] and the optical signal [23]. In this case, the optical multiplexer transmits, to the terminal station 3, the optical signals [13][23] generated by multiplexing the optical signal [13] received from the OADM circuit 110 and the optical signal [23] received from the OADM circuit 120.

### (Other Expression of First Example Embodiment)

The configuration of the optical splitting/coupling device 100 described above can also be described as follows. A reference sign in parentheses indicates a correspondence with the component described in FIGS. 1 and 2.

An optical splitting/coupling device (100) is an optical splitting/coupling device used in an optical submarine cable system (1000). The optical splitting/coupling device (100) includes an integrated OADM circuit (10), and an optical input/output circuit (130) configured to be removably attachable to the integrated OADM circuit (10).

A first optical signal ([12][13]) is input from a first terminal station (1) to the integrated OADM circuit (10), and a second optical signal ([31][32]) is input from an optical input/output circuit (130) to the integrated OADM circuit (10). The integrated OADM circuit (10) generates, from the input optical signals, a third optical signal ([12][32]) having a second terminal station (2) as a destination and a fourth optical signal ([13]) having a third terminal station (3) as a destination. Then, the integrated OADM circuit (10) outputs the fourth optical signal ([13]) to the optical input/output circuit (130).

Further, a fifth optical signal ([21][23]) is input from the second terminal station (2) to the integrated OADM circuit (10), and a sixth optical signal ([31][32]) is input from the optical input/output circuit (130) to the integrated OADM circuit (10). The integrated OADM circuit (10) generates, from the input optical signals, a seventh optical signal ([21][31]) having the first terminal station (1) as a destination and an eighth optical signal ([23]) having the third terminal station (3) as a destination. Then, the integrated OADM circuit (10) outputs the eighth optical signal ([23]) to the optical input/output circuit (130).

Furthermore, the optical input/output circuit (130) generates the second optical signal ([31][32]) and the sixth optical signal ([31][32]) from the optical signal input from the third terminal station (3). The optical input/output circuit (130) outputs the second optical signal ([31][32]) and the sixth optical signal ([31][32]) to the integrated OADM circuit (10). Further, the optical input/output circuit (130) couples and outputs the fourth optical signal ([13]) and the eighth optical signal ([23]) to the third terminal station (3).

### Second Example Embodiment

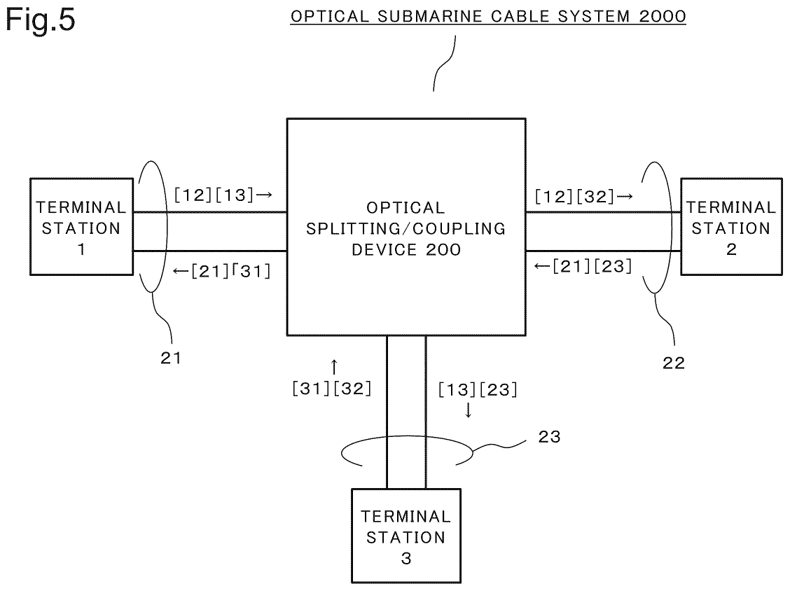

FIG. 5 is a diagram illustrating a configuration example of an optical submarine cable system 2000. The optical submarine cable system 2000 includes an optical splitting/coupling device 200 and terminal stations 1 to 3. The terminal stations 1 to 3 are connected to the optical splitting/coupling device 200 by optical submarine cables 21 to 23, respectively. The optical splitting/coupling device described in PTL 2 can be applied as the optical splitting/coupling device 200 illustrated in FIG. 5. In other words, the optical splitting/coupling device 200 multiplexes/demultiplexes optical signals [12][13] received from the terminal station 1, optical signals [21][23] received from the terminal station 2, and optical signals [31][32] received from the terminal station 3, and generates optical signals transmitted to the terminal stations 1 to 3. Then, the optical splitting/coupling device 200 transmits the optical signals [21][31] to the terminal station 1, transmits the optical signals [12][32] to the terminal station 2, and transmits the optical signals [13][23] to the terminal station 3.

Since a function of the optical splitting/coupling device 200 is similar to that of the optical splitting/coupling device 100, the optical splitting/coupling device 100 can substitute for the optical splitting/coupling device 200 in the optical submarine cable system 2000.

### Third Example Embodiment

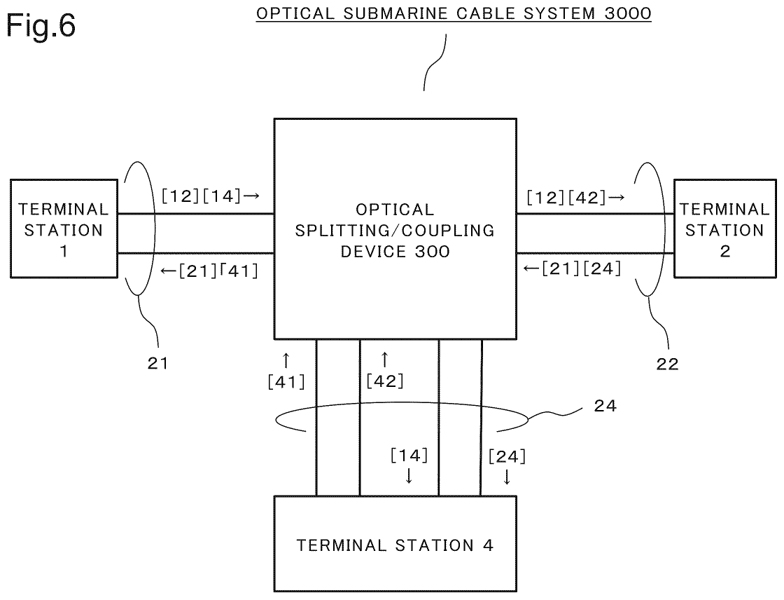

FIG. 6 is a diagram illustrating a configuration example of an optical submarine cable system 3000. The optical submarine cable system 3000 includes an optical splitting/coupling device 300, a terminal station 1, a terminal station 2, and a terminal station 4. The terminal stations 1, 2 and 4 are connected to the optical splitting/coupling device 300 by optical submarine cables 21, 22, and 24, respectively. All of the terminal station 1, the terminal station 2, and the terminal station 4 are a terminal station installed on land.

The optical splitting/coupling device 300 and each of the terminal station 1, the terminal station 2, and the terminal station 4 are communicably connected via the optical submarine cables 21, 22, and 24. The optical submarine cables 21 and 22 bidirectionally transmit an optical signal by two optical fibers having different transmission directions of an optical signal. The optical submarine cable 24 bidirectionally transmits an optical signal between the optical splitting/coupling device 300 and the terminal station 4 by four optical fibers.

A form of an optical signal transmitted and received between the terminal station 1 and the terminal station 2 is similar to that of the optical submarine cable system 1000. In other words, the terminal station 1 transmits optical signals [12][14] to the optical splitting/coupling device 300, and receives optical signals [21][41] from the optical splitting/coupling device 300. Further, the terminal station 2 transmits optical signals [21][24] to the optical splitting/coupling device 300, and receives optical signals [12][42] from the optical splitting/coupling device 300.

Meanwhile, in the optical submarine cable system 3000, the optical splitting/coupling device 300 and the terminal station 4 are connected by four optical fibers. Such a configuration may be adopted when the terminal station 4 does not have a function of wavelength-multiplexing an optical signal transmitted to and received from the optical splitting/coupling device 300 and when there is a sufficient number of optical fibers included in the optical submarine cable 24. In the optical submarine cable system 3000, the four optical fibers between the optical splitting/coupling device 300 and the terminal station 4 each transmit the optical signal [41], the optical signal [42], the optical signal [14], and the optical signal [24].

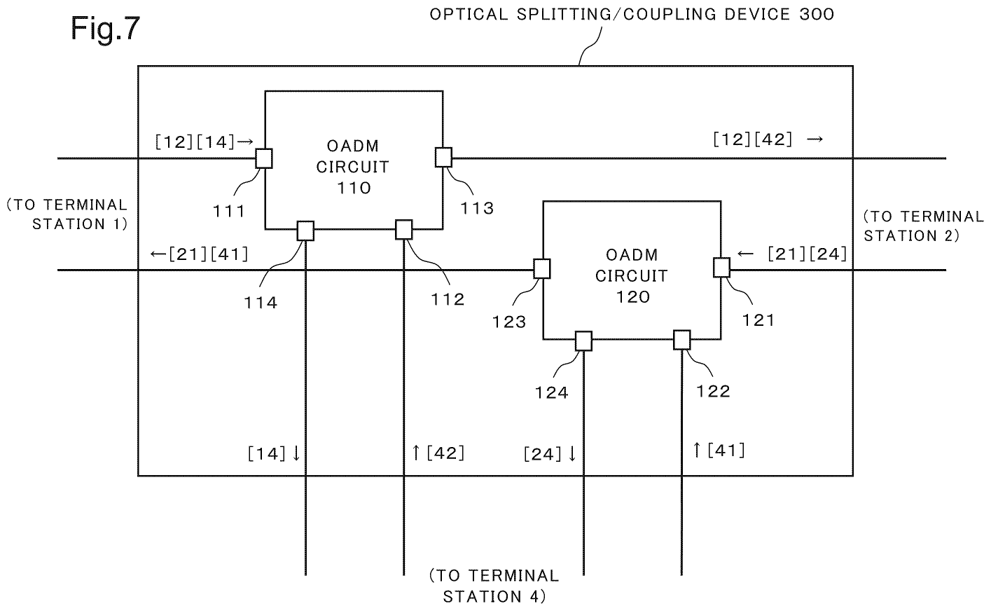

FIG. 7 is a diagram illustrating a configuration example of the optical splitting/coupling device 300. The optical splitting/coupling device 300 includes OADM circuits 110 and 120. In other words, the optical splitting/coupling device 300 has a configuration similar to that of the integrated OADM circuit 10 described in FIG. 2. That is to say, the optical splitting/coupling device 300 is acquired by removing the optical input/output circuit 130 from the optical splitting/coupling device 100. Since the optical input/output circuit 130 is removably attachable to the integrated OADM circuit 10, the integrated OADM circuit 10 can be used as the optical splitting/coupling device 300 alone.

A configuration and an operation of the optical splitting/coupling device 300 are similar to those of the integrated OADM circuit 10. In the present example embodiment, the OADM circuit 110 multiplexes/demultiplexes the optical signals [12][14] received from the terminal station 1 and the optical signal [42] received from the terminal station 4, and generates the optical signals [12][42] and the optical signal [14]. The OADM circuit 110 transmits the optical signals [12][42] to the terminal station 2, and transmits the optical signal [14] to the terminal station 4.

The OADM circuit 120 multiplexes/demultiplexes the optical signals [21][24] received from the terminal station 2 and the optical signal [41] received from the terminal station 4, and generates the optical signals [21][41] and the optical signal [24]. The OADM circuit 120 transmits the optical signals [21][41] to the terminal station 1, and transmits the optical signal [24] to the terminal station 4.

In the optical splitting/coupling device 100, the integrated OADM circuit 10 and the optical input/output circuit 130 are configured to be removably attachable. Therefore, by removing the optical input/output circuit 130 from the optical splitting/coupling device 100, the integrated OADM circuit 10 can be used as the optical splitting/coupling device 300 including the OADM circuits 110 and 120. Then, the optical splitting/coupling device 300 is connected to the terminal station 4 by the optical fiber different for each of the optical signal [41], the optical signal [42], the optical signal [14], and the optical signal [24]. In this way, the integrated OADM circuit 10 can substitute for the existing optical splitting/coupling device 300 in the optical submarine cable system 3000 illustrated in FIG. 6. The existing optical splitting/coupling device 300 is, for example, the device including the OADM circuits 110 and 120 described in FIGS. 3 to 4.

In an optical submarine cable system using, in a mixed manner, the optical splitting/coupling device 200 illustrated in FIG. 5 and the optical splitting/coupling device 300 illustrated in FIG. 6, two kinds of devices of the optical splitting/coupling device 300 and the optical splitting/coupling device 200 need to be secured for maintenance of the optical splitting/coupling device. However, the optical splitting/coupling device 100 according to the present example embodiment includes the optical input/output circuit 130 being removably attachable to the integrated OADM circuit 10, and thus the optical splitting/coupling device 100 can replace both of the optical splitting/coupling device 200 and the optical splitting/coupling device 300. Therefore, in the optical submarine cable system using, in a mixed manner, the optical splitting/coupling device 200 and the optical splitting/coupling device 300 having different forms, the optical splitting/coupling device 100 can be used as common backup equipment.

Note that, the example embodiments of the present disclosure may also be described as supplementary notes below, which is not limited thereto.

### (Supplementary Note 1)

An optical splitting/coupling device used in an optical submarine cable system, the optical splitting/coupling device including:
an integrated OADM circuit; and
an optical input/output circuit configured to be removably attachable to the integrated OADM circuit, wherein
the integrated OADM circuit
   generates, from a first optical signal input from a first terminal station and a second optical signal input from the optical input/output circuit, a third optical signal having a second terminal station as a destination and a fourth optical signal having a third terminal station as a destination, and outputs the fourth optical signal to the optical input/output circuit, and
   generates, from a fifth optical signal input from the second terminal station and a sixth optical signal input from the optical input/output circuit, a seventh optical signal having the first terminal station as a destination and an eighth optical signal having the third terminal station as a destination, and outputs the eighth optical signal to the optical input/output circuit, and
the optical input/output circuit generates the second optical signal and the sixth optical signal from an optical signal input from the third terminal station, outputs the second optical signal and the sixth optical signal to the integrated OADM circuit, and couples and outputs the fourth optical signal and the eighth optical signal to the third terminal station.

### (Supplementary Note 2)

The optical splitting/coupling device according to supplementary note 1, wherein
the integrated OADM circuit includes a first OADM circuit and a second OADM circuit,
the first OADM circuit generates the third optical signal and the fourth optical signal from the first optical signal input from a first terminal and the second optical signal input from the optical input/output circuit connected to a second terminal, outputs the third optical signal from a third terminal, and outputs the fourth optical signal from a fourth terminal to the optical input/output circuit, and
the second OADM circuit generates the seventh optical signal and the eighth optical signal from the fifth optical signal input from a fifth terminal and the sixth optical signal input from the optical input/output circuit connected to a sixth terminal, outputs the seventh optical signal from a seventh terminal, and outputs the eighth optical signal to the optical input/output circuit.

### (Supplementary Note 3)

The optical splitting/coupling device according to supplementary note 1 or 2, wherein
the optical input/output circuit includes a first optical coupler that splits an input optical signal, and a second optical coupler that couples two input optical signals, and connects between the integrated OADM circuit and the third terminal station.

### (Supplementary Note 4)

The optical splitting/coupling device according to supplementary note 3, wherein
the first optical coupler generates the second optical signal and the sixth optical signal from an optical signal input from the third terminal station, and the second optical coupler couples the fourth optical signal to the eighth optical signal.

### (Supplementary Note 5)

The optical splitting/coupling device according to supplementary note 3 or 4, wherein
at least one of the first optical coupler and the second optical coupler is an optical multiplexer/demultiplexer.

### (Supplementary Note 6)

The optical splitting/coupling device according to any one of supplementary notes 1 to 5, wherein
the integrated OADM circuit includes a wavelength selective switch.

### (Supplementary Note 7)

An optical submarine cable system including:
the optical splitting/coupling device according to any one of supplementary notes 1 to 6; and
the first terminal station to the third terminal station.

### (Supplementary Note 8)

The optical submarine cable system according to supplementary note 7, wherein
the first terminal station and the second terminal station are a trunk station, and the third terminal station is a branch station.

### (Supplementary Note 9)

An optical splitting/coupling method of an optical splitting/coupling device that includes an integrated OADM circuit, and an optical input/output circuit configured to be removably attachable to the integrated OADM circuit, and that is used in an optical submarine cable system, the optical splitting/coupling method including:
in the integrated OADM circuit,
generating, from a first optical signal input from a first terminal station and a second optical signal input from the optical input/output circuit, a third optical signal having a second terminal station as a destination and a fourth optical signal having a third terminal station as a destination;
outputting the fourth optical signal to the optical input/output circuit;
generating, from a fifth optical signal input from the second terminal station and a sixth optical signal input from the optical input/output circuit, a seventh optical signal having the first terminal station as a destination and an eighth optical signal having the third terminal station as a destination; and
outputting the eighth optical signal to the optical input/output circuit; and,
in the optical input/output circuit,
generating the second optical signal and the sixth optical signal from an optical signal input from the third terminal station;
outputting the second optical signal and the sixth optical signal to the integrated OADM circuit; and
coupling and outputting the fourth optical signal and the eighth optical signal to the third terminal station.

### (Supplementary Note 10)

The optical splitting/coupling method according to supplementary note 9, further including:
by using a first OADM circuit included in the integrated OADM circuit,
generating the third optical signal and the fourth optical signal from the first optical signal input from a first terminal and the second optical signal input from the optical input/output circuit connected to a second terminal, outputting the third optical signal from a third terminal, and outputting the fourth optical signal from a fourth terminal to the optical input/output circuit; and,
by using a second OADM circuit included in the integrated OADM circuit,
generating the seventh optical signal and the eighth optical signal from the fifth optical signal input from a fifth terminal and the sixth optical signal input from the optical input/output circuit connected to a sixth terminal, outputting the seventh optical signal from a seventh terminal, and outputting the eighth optical signal to the optical input/output circuit.

### (Supplementary Note 11)

The optical splitting/coupling method according to supplementary note 9 or 10, further including,
by using a first optical coupler that splits an input optical signal, and a second optical coupler that couples two input optical signals, which are included in the optical input/output circuit, connecting between the integrated OADM circuit and the third terminal station.

### (Supplementary Note 12)

The optical splitting/coupling method according to supplementary note 11, further including:
by using the first optical coupler, generating the second optical signal and the sixth optical signal from an optical signal input from the third terminal station; and
by using the second optical coupler, coupling the fourth optical signal to the eighth optical signal.

While the present disclosure has been particularly shown and described with reference to the example embodiments, the present disclosure is not limited to the above-described example embodiments. Various modifications that can be understood by those skilled in the art can be made to the configuration and the details of the present disclosure within the scope of the present disclosure. For example, the present disclosure can be applied to not only an optical submarine cable system but also an optical transmission system on land. Further, the description of the optical splitting/coupling device in each of the example embodiments also discloses a configuration of the optical splitting/coupling device and the optical submarine cable system including the terminal station connected to the optical splitting/coupling device, and the optical splitting/coupling method in the optical splitting/coupling device.

Further, the configuration described in each of the example embodiments is not necessarily exclusive. The action and effects of the present disclosure may be achieved by a configuration combining the whole or a part of the above-mentioned example embodiments.

### REFERENCE SIGNS LIST

10 Integrated OADM circuit
21 to 24, 95 to 97 Optical submarine cable
1 to 4, 81 to 83, 91 to 93 Terminal station
85 to 88 Optical fiber
110, 120 OADM circuit
111, 121 First terminal
112, 122 Second terminal
113, 123 Third terminal
114, 124 Fourth terminal
130 Optical input/output circuit
131 to 132 Optical coupler
100, 200, 300, 500 Optical splitting/coupling device
800 to 802, 810, 900 Optical splitting/coupling device
1000, 2000, 3000 Optical submarine cable system
8000 to 8002 Optical submarine cable system

1. An optical splitting/coupling device used in an optical submarine cable system, the optical splitting/coupling device comprising:
an integrated OADM circuit; and
an optical input/output circuit configured to be removably attachable to the integrated OADM circuit, wherein
the integrated OADM circuit
generates, from a first optical signal input from a first terminal station and a second optical signal input from the optical input/output circuit, a third optical signal having a second terminal station as a destination and a fourth optical signal having a third terminal station as a destination, and outputs the fourth optical signal to the optical input/output circuit, and
generates, from a fifth optical signal input from the second terminal station and a sixth optical signal input from the optical input/output circuit, a seventh optical signal having the first terminal station as a destination and an eighth optical signal having the third terminal station as a destination, and outputs the eighth optical signal to the optical input/output circuit, and
the optical input/output circuit generates the second optical signal and the sixth optical signal from an optical signal input from the third terminal station, outputs the second optical signal and the sixth optical signal to the integrated OADM circuit, and couples and outputs the fourth optical signal and the eighth optical signal to the third terminal station.

2. The optical splitting/coupling device according to claim 1, wherein
the integrated OADM circuit includes a first OADM circuit and a second OADM circuit,
the first OADM circuit generates the third optical signal and the fourth optical signal from the first optical signal input from a first terminal and the second optical signal input from the optical input/output circuit connected to a second terminal, outputs the third optical signal from a third terminal, and outputs the fourth optical signal from a fourth terminal to the optical input/output circuit, and
the second OADM circuit generates the seventh optical signal and the eighth optical signal from the fifth optical signal input from a fifth terminal and the sixth optical signal input from the optical input/output circuit connected to a sixth terminal, outputs the seventh optical signal from a seventh terminal, and outputs the eighth optical signal to the optical input/output circuit.

3. The optical splitting/coupling device according to claim 1, wherein
the optical input/output circuit includes a first optical coupler that splits an input optical signal, and a second optical coupler that couples two input optical signals, and connects between the integrated OADM circuit and the third terminal station.

4. The optical splitting/coupling device according to claim 3, wherein
the first optical coupler generates the second optical signal and the sixth optical signal from an optical signal input from the third terminal station, and the second optical coupler couples the fourth optical signal to the eighth optical signal.

5. The optical splitting/coupling device according to claim 3, wherein
at least one of the first optical coupler and the second optical coupler is an optical multiplexer/demultiplexer.

6. The optical splitting/coupling device according to claim 1, wherein
the integrated OADM circuit includes a wavelength selective switch.

7. An optical submarine cable system comprising:
an optical splitting/coupling device used in an optical submarine cable system;
the optical splitting/coupling device including an integrated OADM circuit, and an optical input/output circuit configured to be removably attachable to the integrated OADM circuit,
the integrated OADM circuit being configured to
generate, from a first optical signal input from a first terminal station and a second optical signal input from the optical input/output circuit, a third optical signal having a second terminal station as a destination and a fourth optical signal having a third terminal station as a destination, and output the fourth optical signal to the optical input/output circuit, and
generate, from a fifth optical signal input from the second terminal station and a sixth optical signal input from the optical input/output circuit, a seventh optical signal having the first terminal station as a destination and an eighth optical signal having the third terminal station as a destination, and output the eighth optical signal to the optical input/output circuit,
the optical input/output circuit being configured to generate the second optical signal and the sixth optical signal from an optical signal input from the third terminal station, output the second optical signal and the sixth optical signal to the integrated OADM circuit, and couple and output the fourth optical signal and the eighth optical signal to the third terminal station; and
the first terminal station to the third terminal station.

8. The optical submarine cable system according to claim 7, wherein
the first terminal station and the second terminal station are a trunk station, and the third terminal station is a branch station.

9. An optical splitting/coupling method of an optical splitting/coupling device that includes an integrated OADM circuit, and an optical input/output circuit configured to be removably attachable to the integrated OADM circuit, and that is used in an optical submarine cable system, the optical splitting/coupling method comprising:
in the integrated OADM circuit,
generating, from a first optical signal input from a first terminal station and a second optical signal input from the optical input/output circuit, a third optical signal having a second terminal station as a destination and a fourth optical signal having a third terminal station as a destination;
outputting the fourth optical signal to the optical input/output circuit;
generating, from a fifth optical signal input from the second terminal station and a sixth optical signal input from the optical input/output circuit, a seventh optical signal having the first terminal station as a destination and an eighth optical signal having the third terminal station as a destination; and
outputting the eighth optical signal to the optical input/output circuit; and,
in the optical input/output circuit,
generating the second optical signal and the sixth optical signal from an optical signal input from the third terminal station;
outputting the second optical signal and the sixth optical signal to the integrated OADM circuit; and
coupling and outputting the fourth optical signal and the eighth optical signal to the third terminal station.

10. The optical splitting/coupling method according to claim 9, further comprising:
by using a first OADM circuit included in the integrated OADM circuit,
generating the third optical signal and the fourth optical signal from the first optical signal input from a first terminal and the second optical signal input from the optical input/output circuit connected to a second terminal, outputting the third optical signal from a third terminal, and outputting the fourth optical signal from a fourth terminal to the optical input/output circuit; and,
by using a second OADM circuit included in the integrated OADM circuit,
generating the seventh optical signal and the eighth optical signal from the fifth optical signal input from a fifth terminal and the sixth optical signal input from the optical input/output circuit connected to a sixth terminal, outputting the seventh optical signal from a seventh terminal, and outputting the eighth optical signal to the optical input/output circuit.

11. The optical splitting/coupling method according to claim 9, further comprising,
by using a first optical coupler that splits an input optical signal, and a second optical coupler that couples two input optical signals, which are included in the optical input/output circuit, connecting between the integrated OADM circuit and the third terminal station.

12. The optical splitting/coupling method according to claim 11, further comprising:
by using the first optical coupler, generating the second optical signal and the sixth optical signal from an optical signal input from the third terminal station; and
by using the second optical coupler, coupling the fourth optical signal to the eighth optical signal.
